(19) United States
(12) Patent Application Publication
(10) Pub. No.: US 2006/0211829 A1
(43) Pub. Date: Sep. 21, 2006

(54) Composition for producing flame retardant polyester yarns

(76) Inventors: Matthew B. Studholme, Abingdon, VA (US); Milton K. Roark, Bristol, VA (US); Brendan R. McSheehy JR., Abingdon, VA (US)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/366,799

(22) Filed: Mar. 3, 2006

Related U.S. Application Data
(60) Provisional application No. 60/657,734, filed on Mar. 3, 2005.

(51) Int. Cl. C08G 65/32

(52) U.S. Cl. 525/403

(57) ABSTRACT

A composition for use in making flame-retardant polyester yarns includes about 93 to 99.5% by weight of polyester, from about 0.25 to 4% by weight chain extender, and about 0.25 to 3% by weight polyoxyalkyleneamine.

The present application is related to and claims the priority of Provisional Application Ser. No. 60/657,734, filed Mar. 3, 2005.

### BACKGROUND AND FIELD OF THE INVENTION

This invention relates generally to polyester yarns used in making textiles and floor covering, and more particularly to compositions for making such yarns which provide yarns having improved fire retardancy.

It is very important in complying with modern regulations that products such as textiles and floor coverings made from polyester fibers exhibit adequate flame retardancy. We have invented a new composition which is very effective and economical in providing flame retardant polyester fibers used in making textiles and floor coverings, the yarns otherwise retaining their other desirable physical properties.

### SUMMARY OF THE INVENTION

According to our invention, a composition for preparing polyester-based yarns having improved flame retardancy includes a polyester, one or more polyoxyalkyleneamines and one or more chain extenders. Preferably the composition contains from about 93 to 99.5% by weight of polyester, from about 0.25 to 4% by weight of the chain extender, and from about 0.25% to 3% by weight of polyoxyalkyleneamine. Most preferably, the composition contains from about 96 to 99% by weight of polyester, from about 0.5 to 2% by weight of the chain extender, and from about 0.5% to 2% by weight of polyoxyalkyleneamine.

The polyoxyalkyleneamine(s) may be added directly to the polyester or in the form of a thermoplastic concentrate or masterbatch by compounding it in a suitable thermoplastic carrier. Suitable thermoplastic carriers are polyester or polyamide or mixtures thereof. The polyamide includes those synthesized from lactams, alpha-omega amino acids, and pairs of diacids and diamines. Such polyamides include, but are not limited to, polycaprolactam [polyamide 6], polyundecanolactam [polyamide 11], polyhexamethylene adipamide [polyamide 66], polylauryllactam [polyamide 12], poly(hexamethylene dodecanediamide [polyamide 6,12], poly(hexamethylene sebacamide) [polyamide 6,10], poly(ethylene terephthalate), poly(butylene terephthalate), poly(trimethylene terephthalate). If the polyoxyalklenediamine is used in this masterbatch form, then the amount of polyester in the above formulation is adjusted to take into account the amount of the thermoplastic carrier in the polyoxyalkylenediamine masterbatch.

The preferred polyoxyalkyleneamine is poly(oxyethylene)diamine (POED) with a molecular weight of about 2000. Another preferred polyoxyalkyleneamine that can be used in the invention is poly(oxypropylene)diamine, also with a molecular weight of 2000. These compounds are available from Huntsman Corporation under the Jeffamine® trademark. Further details of suitable polyoxyalkylenediamines are described in U.S. Pat. No. 3,654,370.

Chain extenders, also known as coupling agents, are have at least two functional groups capable of reacting with another compound to link two or more said compounds together. In principle, any bifunctional (or higher functionality) chemical can be used for chain extension or coupling. An example of a suitable chain extender is a multi-funtional reactive material, a further example of which is an epoxy-functional styrene (meth)acrylic copolymer. Suitable multi-functional epoxy compounds, are described in U.S. Patent Application Publication No. U.S. 2004/0138381 A1 to Blasius et al. CESA®-extend 1598, commercially available from Clariant Corporation, is a 20% masterbatch of a oligomeric multi-functional reactive material in a styrenic base. Further details of this masterbatch form are detailed in U.S. Patent Application Publication No. U.S. 2004/0147678 A1 also to Blasius et al. Other examples of suitable chain extenders are those available from Ciba Specialty Chemicals, Inc., under the Irgamod® trademark such as Irgamod RA 20. Other possible chain extenders include, but are not limited to, pyromellitic dianhydride, phenylenebisoxazoline, carbonyl bis(1-caprolactam), diepoxides based on bisphenol A-diglycidyl ether, tetraepoxides based on tetraglycidyl diaminodiphenyl methane.

The chain extender may be added to the composition in a number of different ways. Most preferably, the chain extender is melt compounded or preblended with the polyoxyalkyleneamine or polyoxyalkyleneamine masterbatch prior to addition to the polyester. Alternatively, the chain extender may be added as a concentrate or in masterbatch form to the polyester. The choice of carrier for the chain extender for the masterbatch is dependent on the chain extender functional group reactivity with the carrier resin and range from polyolefin-based resins to similar carrier resins used for preparation of the polyoxyalkeneamine masterbatch to other types known to those persons skilled in the art of masterbatch preparation. In some cases, depending on the chemical and physical nature of the chain extender, it may be added directly to the polyester and the polyoxyalkeneamine at the fiber-spinning extruder.

Polyesters include thermoplastic polyesters such as those synthesized from one or more diacids and one or more glycols. Such polyesters include, but are not limited to, poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), or mixtures thereof.

Besides the polyester, polyoxyalkyleneamines and chain extenders described above, the compositions used in the practice of the invention may contain other components. These include, but are not limited to, colorants, antioxidants, UV stabilizers, antiozonants, soilproofing agents, stainproofing agents, antistatic additives, flame retardants, antimicrobial agents, lubricants, melt viscosity and melt strength enhancers, solid-state polymerization accelerators and processing aids.

Fibers produced from the composition can be melt-spun using various methods to create different products for a multitude of end use applications. The fibers can be spun using standard spinning machinery known to those skilled in the art including both slow speed and high speed spinning processes. A range of denier per filament (dpf) may be produced depending on the ultimate end use to which such fibers may be put, for example low dpf for textile use and higher dpf for use in carpets. The cross-sectional shape of the fibers may also be any of a wide range of possible shapes, including round, delta, trilobal, tetralobal, grooved or irregular.

These product fibers may be subjected to any of the known downstream processes normally carried out on melt-spun fibers, including crimping, bulking, twisting, etc., to produce yarns suitable for incorporation into a variety of articles of manufacture, such as apparel, threads, textiles, upholstery fabrics, carpets and other floorcoverings. The fibers may be blended, entangled, twisted or other mixed with other fiber types including, but not limited to, synthetic fibers such as polyesters, polyolefins or acrylics, or natural fibers such as wool or cotton, and mixtures thereof.

### EXAMPLES OF THE INVENTION

### Example 1

15% by weight of POED was compounded with nylon 6, RV=2.8, in a vented twin-screw extruder, stranded, pelletized and dried. The POED masterbatch was further compounded in a vented twin-screw extruder at the 10% level with PET, IV=0.67, and 2% of CESA®-Extend 1598 and 5% of a light beige color masterbatch (“Rye”) consisting inorganic and organic pigments in a polyester carrier. The resulting compound was spun on a melt-extruder fiber spinning line and air-jet textured to give a bulked continuous filament (BCF) 1300 denier yarn consisting 60 filaments of a Y or trilobe cross-section (1300/60Y). Two ends of the BCF yarn was air twisted together on a Gilbos-type air-twister to produce a nominal 2600/120Y BCF yarn bundle. This yarn was tufted to produce a carpet in a level-loop construction on a 1/10^{th} gauge tufter to give a face weight of 26 oz. The tuft was latex backed.

### Example 2

2% of CESA®-Extend 1598 with PET, IV=0.67, and 5% of the Rye color masterbatch were melt-compounded in a twin-screw extruder. The resulting compound was processed in a manner similar to Example 1 to produce a 2600/120Y BCF yarn. A carpet was produced from the BCF yarn in a similar construction to that described in Example 1.

### Example 3

A comparative (non-inventive) 2600/120Y BCF yarn was spun, air-textured and air-twisted in a similar manner to Example 1 consisting 5% of the Rye color masterbatch with the same IV=0.67 PET. The color masterbatch and the PET were pre-melt-compounded prior to melt-spinning the yarn. The BCF yarn was tufted and backed to give a carpet of similar construction to that described in Example 1.

### Example 4

10% of the POED masterbatch described in Example 1 was compounded with with PET, IV=0.67, and 5% of the Rye color masterbatch were melt-compounded in a twin-screw extruder. The resulting compound was processed in a manner similar to Example 1 to produce a 2600/120Y BCF yarn. A carpet was produced from the BCF yarn in a similar construction to that described in Example 1.

The carpets produced in Examples 1-4 were tested for flame retardancy per ASTM E648-03, “Standard Test Method for Critical Radiant Flux of Floor-Covering Systems Using a Radiant Heat Energy Source”. The results are shown in table 1 below. The critical radiant flux indicates the level of radiant heat energy required to sustain flame propagation in the carpet once it has been ignited. A higher critical radiant flux indicates that the carpet has greater flame retardancy.

TABLE 1

| Example Number | Critical Radiant Flux/Wcm⁻² |
|---|---|
| Example 1 | 0.53 |
| Example 2 | 0.38 |
| Example 3 | 0.32 |
| Example 4 | 0.40 |

The flame retardancy testing results of Examples 1-4 detailed in Table 1 show that the inclusion of the chain extender and the polyoxyalkyleneamine separately, (Examples 2 and 4 respectively), when incorporated into a polyester polymer matrix give small improvements in flame retardancy over an unmodified polyester (Example 3). It was surprisingly found that the addition of both the chain extender and the polyoxyalkyleneamine to the polyester matrix (Example 1) gave a significant improvement in flame retardancy over the unmodified polyester (Example 3).

### Example 5

10 parts of the POED masterbatch described in Example 1 was melt-compounded with 2 parts of Irgamod RA 20. The resultant compound was added to PET, IV=0.67, directly on a fiber-spinning line at a level of 12% and air-jet textured to produce a 1300/60Y BCF natural yarn. Two ends of the yarn produced were air-twisted together and the twisted yarn was tufted into a level-loop carpet construction with a yarn face weight of 20 oz. and latex-backed.

### Example 6

A second POED masterbatch/Irgamod RA 20 was compounded in a similar manner to Example 5 in a ratio of 5 parts of POED masterbatch to 2 parts of Irgamod RA 20 was added to PET, IV=0.67, directly on a fiber-spinning line at a rate of 7% and air-jet textured to produce a 1300/60Y BCF natural yarn. Two ends of the yarn produced were air-twisted together and the twisted yarn was tufted into a level-loop carpet construction with a yarn face weight of 20 oz. and latex-backed.

### Example 7

A natural yarn (no additives included) was spun and air-jet textured from PET resin, IV=0.67, to give a 1300/60Y BCF yarn. Two ends of the BCF yarn were air-twisted together and the twisted yarn was tufted into a level-loop carpet construction with a yarn face weight of 20 oz. and latex-backed.

The carpets produced in Examples 5-7 were tested for flame retardancy per ASTM E648-03. The critical radiant flux of Examples 5 and 6 were 0.51 Wcm⁻² and 0.49 Wcm⁻² respectively. The critical radiant flux of Example 7 was 0.33 Wcm⁻². Both the inventive compositions (Examples 5 and 6) showed improved flame retardancy over the control Example 7.

### Example 8

10 parts of the POED masterbatch described in Example 1 was compounded with 0.6 parts of a 50% masterbatch of titanium dioxide, 2 parts of CESA®-extend 1598 and 87.4 parts of polypropylene terephthalate resin, IV=0.90, on a vented twin-screw extruder. The resulting compound was spun and air-jet textured to give a 1300/60Y BCF yarn. Two ends of the BCF yarn were air-twisted together and the twisted yarn was tufted into a level-loop carpet construction with a yarn face weight of 20 oz. and latex-backed.

### Example 9

0.6 parts of a 50% masterbatch of titanium dioxide and 99.4 parts of polypropylene terephthalate resin, IV=0.90, were compounded, spun and air-jet textured to give a 1300/60Y BCF yarn. Two ends of the BCF yarn were air-twisted together and the twisted yarn was tufted into a level-loop carpet construction with a yarn face weight of 20 oz. and latex-backed.

Examples 8 and 9 were tested for flame retardancy per ASTM e648-03. Example 8 had a critical radiant flux of 0.33 Wcm⁻². The (control) Example 9 sample gave a critical radiant flux of 0.19 Wcm⁻². As with the previous Examples, the inventive composition (Example 8) showed a significant improvement of flame retardancy over the non-inventive (Example 9) comparative sample.

The foregoing examples are presented to demonstrate the advantages of the invention. The specific techniques, conditions, materials, proportions and reported data set forth to illustrate the principles of the invention are exemplary and should not be construed as limiting the scope of the invention.

We claim:

1. A flame-retardant composition comprising:
(a) thermoplastic polyester,
(b) a polyoxyalkyleneamine, and
(c) a chain extender.

2. A composition as defined in claim 1, wherein said thermoplastic polyester is a fiber-forming thermoplastic polyester.

3. A composition as defined in claim 1, wherein said thermoplastic polyester comprises a polyester selected from the group consisting of poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), and mixtures thereof.

4. A composition as defined in claim 1, wherein said polyoxyalkyleneamine comprises a compound selected from the group consisting of poly(oxyethylene)diamine and poly(oxypropylene)diamine, and mixtures thereof.

5. A composition as defined in claim 1, wherein said chain extender is a multi-functional reactive material.

6. A composition as defined in claim 5, wherein said multi-functional reactive material is a epoxy-functional styrene (meth)acrylic copolymer.

7. A composition as defined in claim 5, wherein said multi-functional reactive material comprises a compound selected from the group consisting of pyromellitic dianhydride, phenylenebisoxazoline, carbonyl bis(1-caprolactam), diepoxides based on bisphenol A-diglycidyl ether, tetraepoxides based on tetraglycidyl diaminodiphenyl methane, and mixtures thereof.

8. A composition as defined in claim 1, containing from about 93 to 99.5% by weight polyester, from about 0.25 to 4% by weight chain extender, and from about 0.25 to 3% by weight polyoxyalkyleneamine.

9. A composition as defined in claim 8, containing from about 96 to 99% by weight polyester, from about 0.5 to 2% by weight chain extender, and from about 0.5 to 2% by weight polyoxyalkyleneamine.

10. A flame-retardant composition comprising:
(a) a thermoplastic polyester,
(b) a concentrate including both a polyoxyalkylenediamine and a thermoplastic polyamide or a thermoplastic polyester carrier resin, and
(c) a chain extender.

11. A composition as defined in claim 8, wherein said thermoplastic polyester is a fiber-forming thermoplastic polyester.

12. A composition as defined in claim 8, wherein said thermoplastic polyester comprises a polyester selected from the group consisting of poly(ethylene terephthalate, poly(butylene terephthalate), poly(propylene terephthalate), poly(ethylene naphthalate), poly(propylene naphthalate), poly(butylene naphthalate), poly(cyclohexane dimethanol terephthalate) and poly(lactic acid), and mixtures thereof.

13. A composition as defined in claim 8, wherein said polyoxyalkyleneamine comprises a compound selected from the group consisting of poly(oxyethylene)diamine and poly(oxypropylene)diamine, and mixtures thereof.

14. A composition as defined in claim 8, wherein said chain extender is a multi-functional reactive material.

15. A composition as defined in claim 12, wherein said multi-functional reactive material is a epoxy-functional styrene (meth)acrylic copolymer.

16. A composition as defined in claim 12, wherein said multi-functional reactive material comprises a compound selected from the group consisting of pyrometallic dianhydride, phenylenebisoxazoline, carbonyl bis(1-caprolactam), diepoxides based on bisphenol A-diglycidyl ether, tetraepoxides based on tetraglycidyl diaminodiphenyl methane, and mixtures thereof.

17. A composition as defined in claim 8, wherein said thermoplastic polyamide or thermoplastic polyester carrier resin comprises a polyamide selected from the group consisting of polyamide 6, polyamide 11, polyamide 66, polyamide 12, polyamide 6,12, polyamide 6,10, poly(ethylene terephthalate), poly(butylene terephthalate), poly(trimethylene terephthalate), and mixtures thereof.
